(19) United States
(12) Patent Application Publication
(10) Pub. No.: US 2006/0229936 A1
(43) Pub. Date: Oct. 12, 2006

(54) Method and apparatus for rewarding a customer referral

(76) Inventor: Conor P. Cahill, Waterford, VA (US)

Correspondence Address: Jack J'maev;Suite L, 14175 Telephone Ave., Chino, CA, 91710, US

(21) Appl. No.: 11/100,353

(22) Filed: Apr. 6, 2005

(51) Int. Cl. G06Q 30/00

(52) U.S. Cl. 705/14

(57) ABSTRACT

A method and apparatus for rewarding a customer referral by recognizing a referring customer, noting a purchase of a product, receiving a referral directive from the referring customer, determining a refer-to customer and dispatching a referral to the determined refer-to customer.

### BACKGROUND

Personal referral is a powerful marketing tool. When compared with impersonal advertising messages received from strangers, a referral from someone a consumer knows is likely to receive more attention and be received with less skepticism. Compare, for example, a personally sent email to a spam email that many people now receive. Spam email is a form of “blitz” marketing that, today, is almost entirely ineffective. One problem with spam email is that when an email arrives in a person's in-box, it is simply deleted if a user does not recognize the sender of the email. In fact, this type of response is now automated by various spam filters offered by Internet service providers. A user only needs to specify a list of recognized senders. When an email arrives from someone other than a sender enumerated in the recognized sender list, the email is automatically deleted.

Despite its power, personal referral is not exploited by businesses on a large scale (relative to its potential). Within any given industry or peer-group, people often refer products or services to each other. Businesses would like to have their customers refer new customers. This, though, is a rarity when compared to the number of individuals that may participate in a particular industry or belong to a particular peer-group. The reason for this is quite plain—any particular customer may only know a limited number of other potential customers and, even if they may know someone that would be interested in purchasing a referred product or service, the original customer may not remember to mention how satisfied they were with the product or service that ought to be recommended. In other cases, the original customer simply has no motivation to recommend a product or service, no matter how satisfied, or even impressed by the quality of the product or service they may be.

Customer referral programs are a well known method for increasing business. These well known methods take advantage of the personal relationship one customer may have with other potential customers. These traditional referral programs are most often employed by local businesses; small retailers and service providers. Optometrists, dry-cleaners, produce markets and other small businesses can all benefit when a current customer recommends their product or service to a new person. One thing to appreciate is that these traditional customer referral programs are not effective unless the service is of a more personal nature (doctor or dentist) or a product is of a particularly high quality or value. Garden variety services and low-cost, high volume products are seldom considered to be worthy of a personal recommendation from one friend to another.

Given the powerful influence of person and referrals and the shortcomings of traditional methods of exploiting interpersonal relationships, it would be highly desirable to have a method that efficiently motivates an average consumer to make personal referrals, and to do so routinely and in a manner suitable even for the most ordinary and common product (e.g. laundry soap).

### SUMMARY

A method and apparatus for rewarding a customer referral by recognizing a referring customer, noting a purchase of a product, receiving a referral directive from the referring customer, determining a refer-to customer and dispatching a referral to the determined refer-to customer.

### BRIEF DESCRIPTION OF THE DRAWINGS

Several alternative embodiments will hereinafter be described in conjunction with the appended drawings and figures, wherein like numerals denote like elements, and in which:

FIG. 1 is a pictorial diagram that depicts various illustrative use cases for a method for rewarding a customer referral;

FIG. 2 is a flow diagram that depicts one example method for rewarding a customer referral;

FIG. 3 is a flow diagram that depicts an alternative example method for recognizing a referring customer;

FIG. 4 is a flow diagram that depicts one illustrative alternative method for recognizing a referring customer;

FIG. 4A is a flow diagram that depicts one alternative example method for noting a purchase by a referring customer;

FIG. 5 is a flow diagram that depicts one example alternative method for receiving a referral directive from a referring customer;

FIG. 6 is a flow diagram that depicts one example method for reminding the referring customer of a purchase;

FIG. 7 is a flow diagram that depicts an alternative example method for receiving a recommendation level;

FIG. 8 is a flow diagram that depicts one alternative example method for determining a refer-to customer;

FIG. 9 is a flow diagram that depicts one example method for dispatching a referral to a predetermined refer-to customer;

FIG. 10 is a flow diagram that depicts one occurred of method for rewarding a customer referral;

FIG. 11 is a flow diagram that depicts various alternative illustrative methods for determining when an incentive should be provided to a referring customer;

FIG. 12 is a flow diagram that depicts alternative methods for determining a form of an incentive for a referring customer;

FIG. 13 is a flow diagram that depicts yet another variation of a method for determining when an incentive is provided to a referring customer based on the action of a refer-to customer;

FIG. 14 is a flow diagram that depicts an alternative example method for determining when a refer-to customer purchases a recommended item;

FIG. 15 is a block diagram that depicts several alternative example embodiments of an apparatus for rewarding a customer referral;

FIG. 16 is a pictorial diagram that illustrates one example embodiment of a user table;

FIG. 17 is a pictorial diagram that illustrates one example embodiment of a referral list;

FIG. 18 is a pictorial diagram that illustrates one example embodiment of a purchase table;

FIG. 19 is a pictorial diagram that illustrates one example embodiment of a promotional item list; and

FIGS. 20 and 21 collectively constitute a data flow diagram that illustrates the internal operation of several example alternative embodiments of an apparatus for rewarding a customer referral.

### DETAILED DESCRIPTION

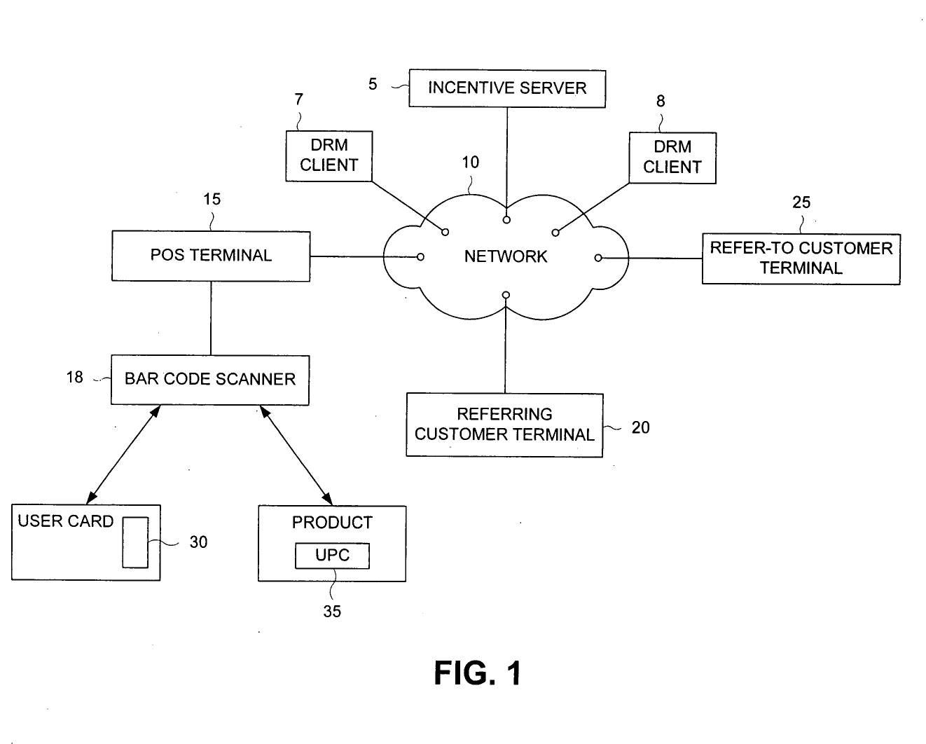

FIG. 1 is a pictorial diagram that depicts various illustrative use cases for a method for rewarding a customer referral. The present method and various embodiments thereof are applicable in a situation where a referring customer accesses one embodiment by means of a referring customer terminal 20. Typically, the referring customer terminal 20 provides communications by means of a network 10 so as to enable communications with an incentive server 5. In operation, the referring customer terminal 20 allows a referring customer (i.e. a user) to interact with the incentive server 5.

Typically, a referring customer uses the referring customer terminal 20 to create an account on the incentive server 5. The user account created on the incentive server 5 facilitates an incentive mechanism wherein a referring customer is rewarded for making recommendations with respect to the purchase of a product or a service. It should be appreciated that the present method and various embodiments thereof may be used in a wide variety of applications and the purchase of a product or service are only two examples where the present method may be applied. Accordingly, the claims appended hereto are not intended to be limited in scope to any particular application of the present method and various embodiments thereof.

According to one illustrative use case, the present method and apparatus are utilized in conjunction with a digital rights management system. A digital rights management (DRM) system allows content (e.g. text, images, video, audio, interactive multimedia content, software) to be published in protected form and with usage rules enforced. In a digital rights management system, the usage rules associated with content are set by the publisher of the content. Published content is typically protected by cryptographic techniques, such as encryption and authentication. Protected content can be distributed to consumers via various channels, such as communication networks or in the form of physical media. Consumer access to protected content is mediated by a digital rights management client module, which enforces usage rules specified by the publisher. A digital rights management client module typically has a unique identity and is typically protected by tamper-resistant packaging, software tamper-resistance techniques, or a combination of both. In order to access protected content, a digital rights management client module (acting as a surrogate of the consumer) requires an appropriate license from the publisher of the content.

A license in a digital rights management system is a data structure that conveys access rights to a digital rights management client module or (a group of DRM client modules). Licenses are typically protected by cryptographic techniques so that it would be infeasible for unauthorized parties to forge or undetectably modified them. Licenses are generated by one or more license servers, which have access to the requisite cryptographic keys for license generation. License servers are typically secured by a combination of physical, software, and procedural security measures, and are often accessible via a communication network. Many types of usage rules (i.e. access policies) can be enforced by digital rights management systems. Examples of usage rules include: perpetual license, pay-per-use, time-limited license, license limited by number of plays/executions, copying allowed/disallowed. Other kinds of usage rules and access privileges are also known. License acquisition is often coupled with a payment process, so that a consumer can obtain licenses in exchange for payment. License acquisition and payment processes are typically automated and take place over a communication network, but they can also use other means of communication and may be mediated by personnel.

In a digital rights management system that supports lending, a first digital rights management client module 7 (the lender device) temporarily transfers access rights associated with a license to a second digital rights management client module 8 (the borrower device) in a lending transaction. While a license is on loan, the borrower device 8 can exercise the rights associated with the loaned license but the lender device cannot. A license on loan can be returned to the lender device 7 in a returning transaction, or it can be restored to the lender device 7 based on expiration of the loan. In this context, a referring user can make a recommendation to purchase a copy of a particular media, thus enabling a customer referral award to the user that loaned a license.

According to this illustrative use case, a user is rewarded for making referrals by registering with the incentive server 5. At a minimum, registration records an association between a unique identifier of a digital rights management client module controlled by the consumer and a minimum set of information usable for issuing incentive to the consumer. The registration process transmits such association information to the incentive server 5, a component provided by the present embodiment. The incentive server 5 collects information on referrals and referral-related purchases, computes awards of incentive according to the rules of the incentive program, and optionally issues incentive to referring consumers. The incentive server 5, according to one alternative embodiment, is implemented either as a centralized system or as a distributed system. Additional information about the consumer is collected and stored by the incentive server 5, at least according to one alternative variation of the present method and apparatus. Identifiers used for identifying a digital rights management client module and for issuing incentive need not be specifically created for the purposes. For example, an identifier for the first digital rights management client module 7, according to one alternative embodiment, includes a native identifier used in the digital rights management system for identifying the module. The minimum set of information usable for issuing incentive depends on the form of incentive provided, and the form of payment if the incentive is at least in part monetary.

As already discussed, a lending transaction initiated by a first digital rights management client 7 is treated as an act of referral. A referral is recorded by at least one of the lender device 7 and the borrower device 8. Such a referral record is then conveyed to the incentive server 5 either at lending time, or when the referred consumer purchases an item that was previously borrowed. The conveyance of a referral record and purchase information to the incentive server 5 is preferably accomplished by means of the network 10. The incentive system 5 processes the referral and purchase information to compute incentive awards according to the techniques and teachings set forth herein.

Once a referring customer establishes an account on the incentive server 5, the referring customer may purchase a product or service. Such a purchase is typically made at a retail establishment, but this is only one example where the present method may be applied. According to one illustrative use case, a point-of-sale (POS) terminal 15 is used to affect the purchase of a product or service. During a purchase transaction, the point-of-sale terminal 15, which according to one alternative embodiment includes a barcode scanner 18, the referring customer is recognized by the system. Typically, the point-of-sale terminal 15 uses the barcode scanner 18 to recognize a referring customer. Typically this is done by means of a user token (e.g. a user identification card 30). Such a user identification card 30 will typically include a barcode user identifier which is perceived by the barcode scanner 18. The point-of-sale terminal 15 then uses the barcode scanner 18 to perceive a second barcode 35, which is typically associated with a product or a service. It should be appreciated that a product or a service is typically identified by means of a stock keeping unit (SKU) number, a Universal Product Code (UPC) symbol or some other form of inventory identification number.

The incentive server 5 then receives from the point-of-sale terminal 15 a message that reflects the fact that a particular user, identified by a user identification number, has purchased a particular product or service, which is identified by some form of inventory identification number. The incentive server 5 then notes the purchase for future use. At some point in the future, preferably after a referring customer has had an opportunity to evaluate the product or service, the referring customer is given an opportunity to recommend the previously purchased product or service. Accordingly, a referring customer uses the referring customer terminal 20 to direct the incentive server 5 to dispatch a recommendation to one or more contacts. It should be appreciated that the one or more contacts are typically specified by the referring customer when the referring customer establishes an account on the incentive server 5. It should be appreciated that the referring customer, according to one variation of the present method, is able to modify the list of contacts at any time. This list of contacts is also known as a “referral list”.

When the referring customer chooses to recommend a particular product or service, the incentive server 5 dispatches a recommendation to a “refer-to” customer. Typically, the refer-to customer uses a refer-to customer terminal 25 to receive the recommendation according to a recommendation directive received by the incentive server 5 from the referring customer terminal 20. According to one variation of the present method, a referring customer is given an incentive whenever a recommendation is made to one or more contacts that the referring customer has previously specified. In another variation of the present method, the referring customer is given an incentive whenever a refer-to customer actually purchases a product according to a recommendation the refer-to customer receives from the incentive server 5.

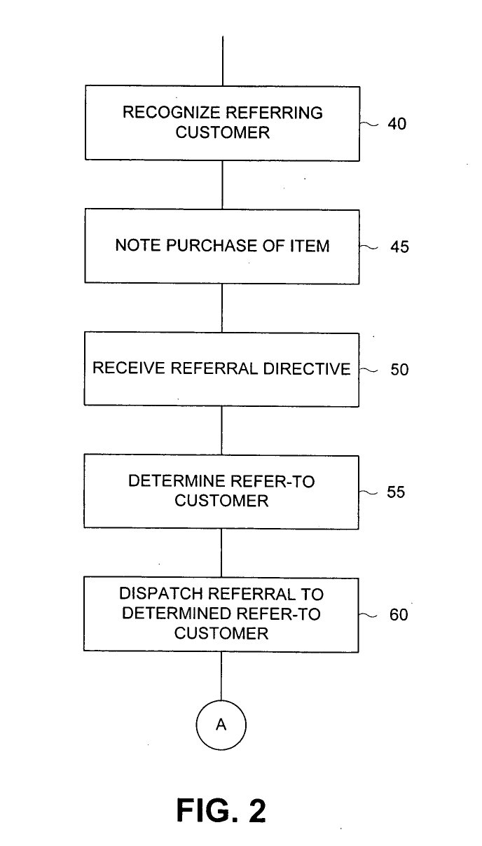

FIG. 2 is a flow diagram that depicts one example method for rewarding a customer referral. According to this example method, a customer referral is rewarded by first recognizing a referring customer (step 40). A purchase of a particular item is then noted (step 45). It should be appreciated that an item includes, but is not limited to a product, a service, and an accommodation (e.g. a hotel room). At some point in the future, a referral directive is received (step 50). It should be appreciated that the referral directive is typically received from a referring customer. Upon receipt of the referral directive, a refer-to customer is determined (step 55). The referral (e.g. a recommendation) is then dispatched to the determined refer-to customer (step 60).

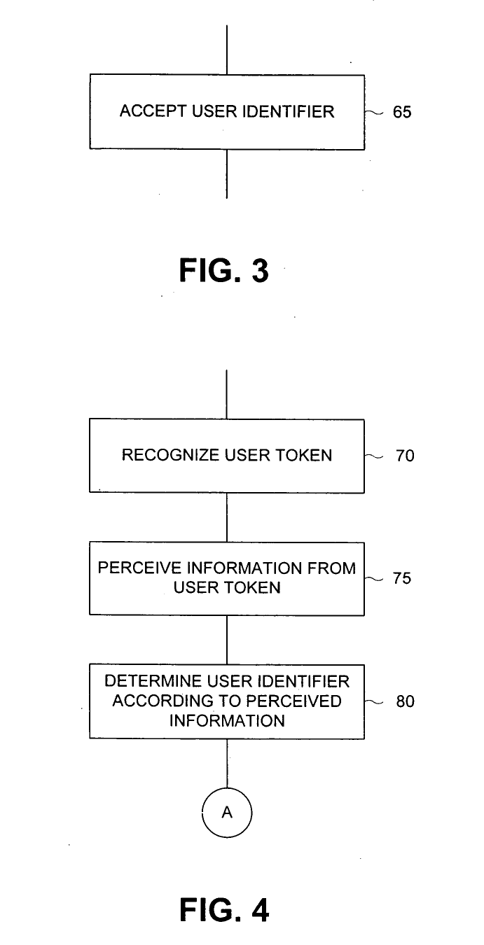

FIG. 3 is a flow diagram that depicts an alternative example method for recognizing a referring customer. According to this alternative method, a referring customer is recognized by accepting a user identifier (step 65). Typically, a referring customer establishes an account so as to facilitate the granting of incentive once the referring customer recommends a particular item. According to this variation of the present method, the referring customer establishes an account that is identified according to a user identifier.

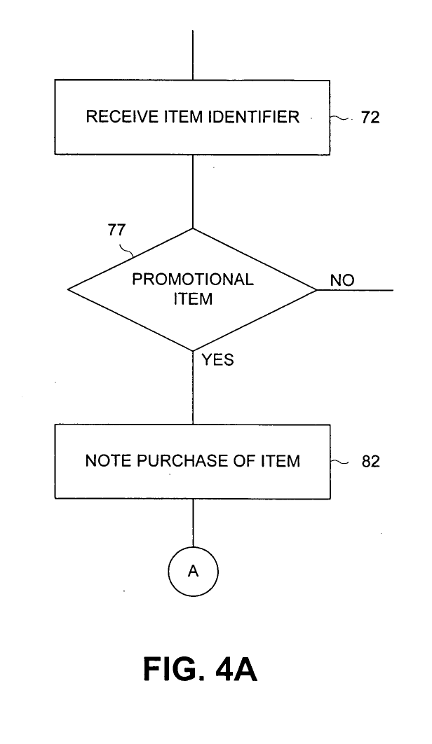

FIG. 4 is a flow diagram that depicts one illustrative alternative method for recognizing a referring customer. According to this alternative illustrative method, a referring customer is recognized by recognizing a user token (step 70). A user token includes, but is not limited to a user identification card that includes a barcode. Another form of a user token comprises a wireless identification transponder (e.g. a SmartChip or a radio-frequency identification chip (RFID). Information included in the user token is then perceived (step 75). A user identifier is then determined according to the perceived information (step 80). As heretofore described, one illustrative use case provides for a user identification card that includes a barcode. According to this illustrative use case, the barcode is perceived and a user identifier is then determined according to the perceived information. Typically, the barcode will be encoded so as to reflect a user identifier that can be accepted by an incentive server 5.

FIG. 4A is a flow diagram that depicts one alternative example method for noting a purchase by a referring customer. According to this alternative example method, the purchase of an item by a referring customer is noted by first receiving an item identifier (step 72). When the item identifier corresponds to a promotional item (step 77), the purchase of the item is noted (step 82). It should be appreciated that, according to one illustrative use case, not every item available for purchase should be noted when such purchase is made. Typically, a manufacturer or a retailer will be desirous of promoting a particular product or service. Accordingly, a fee may be charged to the manufacturer or to the retailer so as to include a particular item in a promotional item list. As such, when the item is found in a promotional item list, purchase of that item is noted when a referring customer purchases said product or service.

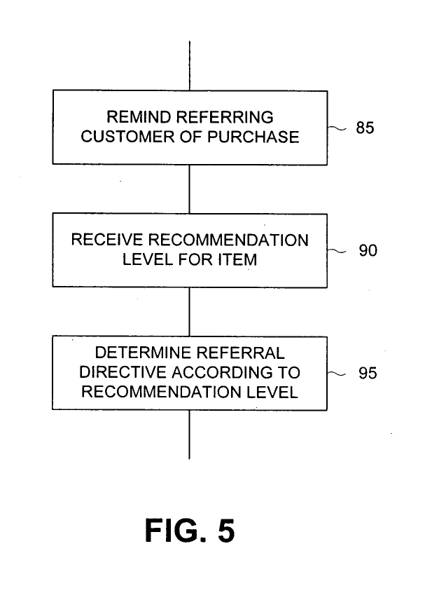

FIG. 5 is a flow diagram that depicts one example alternative method for receiving a referral directive from a referring customer. According to this example alternative method, a referral directive is received by first reminding a referring customer of a previous purchase (step 85). Once reminded, a referring customer may voluntarily choose to issue a recommendation directive. Accordingly, one variation of the present method provides for receiving a recommendation level for an item (step 90). The recommendation level for an item, according to one variation of the present method, is received in the form of a preference for particular item. For example, a recommendation level for an item can be received in the form of a multi-tiered rating; “poor”, “satisfactory” and “fantastic” are three example levels in a multi-tiered rating scheme. A recommendation, according to this variation of the present method, is issued upon a fantastic rating received from a referring customer. According to yet another variation of the present method, the recommendation level for an item comprises a two-level rating; “no recommendation” and “recommend” are two examples of these. As such, the recommendation level for an item received from a referring customer, according to this variation of the present method, comprises either a recommendation directive or a non-recommendation directive. In either case, a referral directive is determined according to a received recommendation level (step 95).

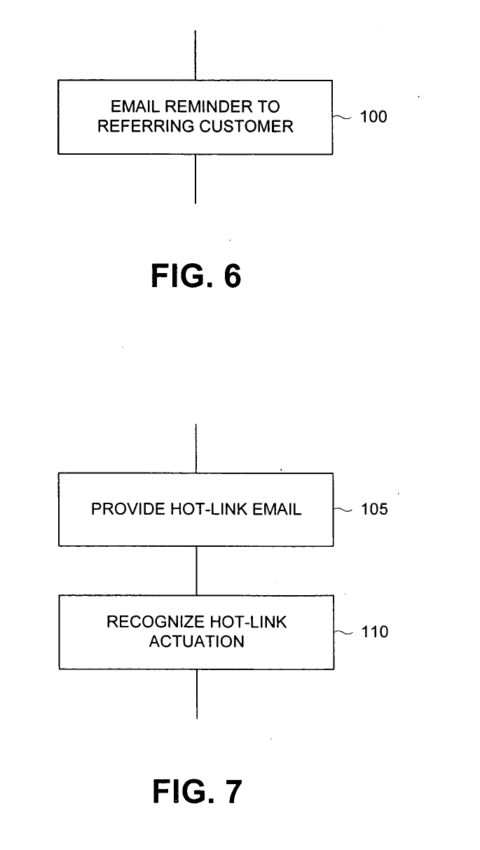

FIG. 6 is a flow diagram that depicts one example method for reminding the referring customer of a purchase. According to this example method, a referring customer is reminded of a purchase by dispatching an e-mail reminder to the referring customer (step 100). It should be appreciated that, according to this variation of the present method, a referring customer will typically provide an e-mail address when such referring customer establishes an account on an incentive server.

FIG. 7 is a flow diagram that depicts an alternative example method for receiving a recommendation level. According to this example alternative method, a recommendation level for a particular item is received by providing a hot-link in an e-mail (step 105). According to this alternative example method, actuation of the hot-link is recognized (step 110). It should be appreciated that, according to yet another illustrative variation of the present method, an e-mail used to remind a referring customer of a previous item purchase includes such a hot-link. Typically, such a hot-link will direct an e-mail client (or a Web browser) to a web page on a server. When an e-mail client or a Web browser is directed to a particular web page on a particular server, according to the hot-link, the server responds by receiving a recommendation level according to the hot-like. It should be further appreciated that a plurality of hot-links, according to yet another variation of the present method, are provided. According to this variation of the present method, each of the hot-links provided corresponds to a particular satisfaction level. Accordingly, a user only needs to actuate one of the hot-links in order to convey a preference level for a particular item.

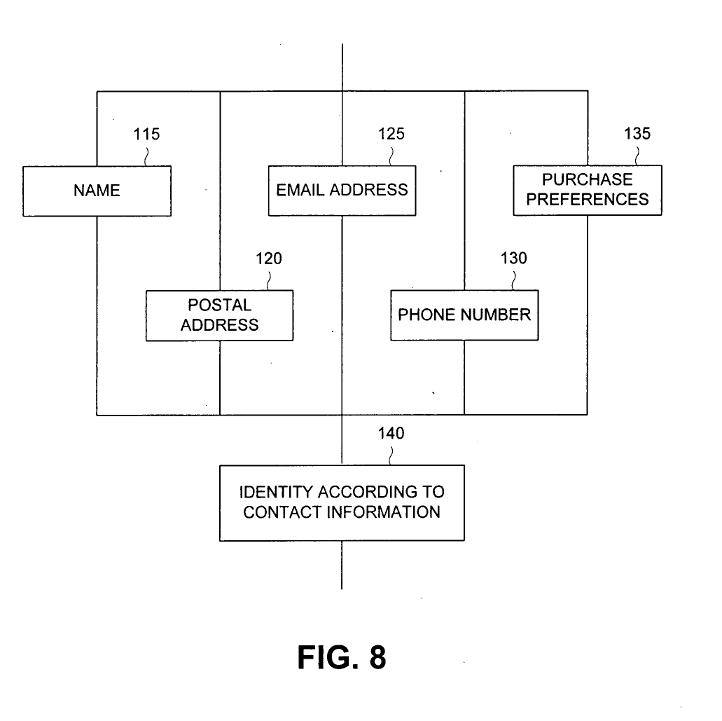

FIG. 8 is a flow diagram that depicts one alternative example method for determining a refer-to customer. According to this alternative example method, a refer-to customer is determined by receiving contact information from the referring customer. It should be appreciated that, according to various example variations of the present method, contact information received from a referring customer includes, but is not limited to a name (step 115), a postal address (step 120), an e-mail address (step 125) and a phone number (step 130). Using such contact information, a refer-to customer is identified (step 140). Such contact information, according to yet another variation of the present method, is used to direct a referral (e.g. a recommendation) to a determined to refer-to customer. It should be appreciated that these are merely example contact information types and are presented herein to further illustrate the present method and are not intended to limit the scope of the claims appended hereto.

It should be appreciated that, according to yet another variation of the present method, purchase preference information (step 135) is used to identify a particular refer-to customer. In this variation of the present method, a particular item purchased by a referring customer is categorized. Various products and/or service categories include, but are not necessarily limited to automotive products, electronic products and beauty services. The price of a products or service is also used as a category discriminator or according to yet another variation of the present method, it should be appreciated that a recommendation for a particular item may not necessarily be applicable to all contacts identified by the referring user in the referring user's referral list. For example, pediatric care services may not be applicable to a particular contact that is a senior-citizen.

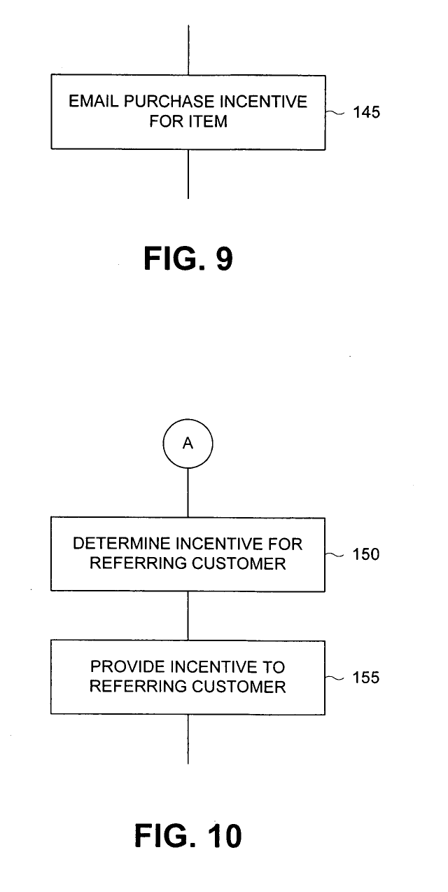

FIG. 9 is a flow diagram that depicts one example method for dispatching a referral to a predetermined refer-to customer. The according to this example alternative method, a referral is dispatched to a refer-to customer by e-mailing a purchase incentive for the recommended item (step 145). It should be appreciated that according to this variation of present method, an e-mail is directed to a particular contact according to an e-mail address associated with a particular contact included in a referring customer's referral list. According to yet another variation of the present method, the purchase incentive included in an e-mail further includes machine-readable information that reflects the source of a referral. For example, a purchase incentive (e.g. in the form of a coupon) directed to a determined refer-to contact, according to yet another variation of the present method includes a barcode encoded with the referring customer's user identifier. When the refer-to customer redeems the purchase incentive, a point-of-sale terminal can be used to perceive the referring customer's user identifier. This referring customer's user identifier can then be communicated to an incentive server in order to facilitate the award of an incentive to the referring customer.

FIG. 10 is a flow diagram that depicts one occurred of method for rewarding a customer referral. According to this alternative method, a customer referral is rewarded by further determining an incentive for the referring customer (step 150). Once a referral is made, a referring customer is provided an incentive (step 155) according to the determined incentive.

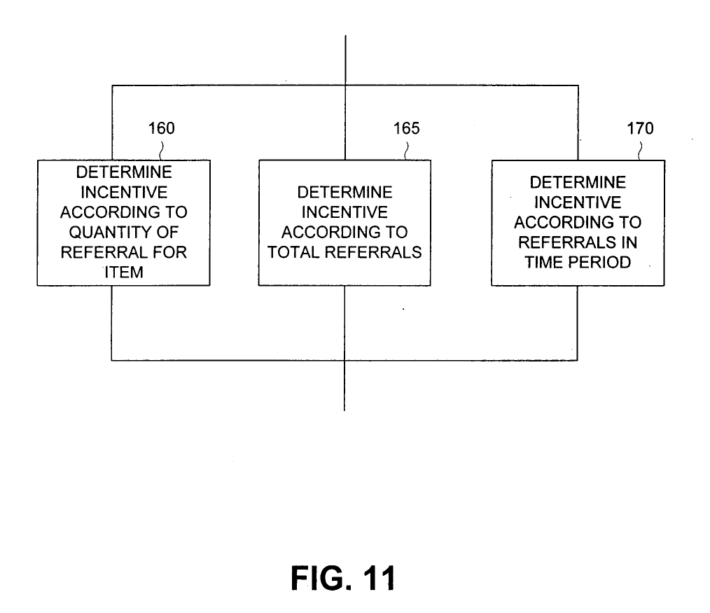

FIG. 11 is a flow diagram that depicts various alternative illustrative methods for determining when an incentive should be provided to a referring customer. It should be appreciated that, according to one variation of the present method, the total number of referrals made for a particular item is used to determine an incentive for a referring customer (step 160). In a practical sense, when a particular promotional item is the subject of a purchase, the manufacturer or retailer that is desirous of promoting the particular item may establish an incentive level which dictates a minimum quantity of referrals made for a particular item by a particular referring customer before an incentive is provided to the referring customer.

In yet another variation of the present method, the total number of referrals made by a particular referring customer is used to determined incentive (step 165). According to this variation of the present method, a referring customer is provided with an incentive once the referring customer has made a minimum number of recommendations. It should be appreciated that, according to yet another variation of the present method, various tiers are established in order to provide an additional incentive for referring an item to a contact in the referring customer's referral list. For example, once a referring customer has made a minimum quantity of recommendations, a first incentive level is provided to the referring customer. According to one illustrative use case, a second total referral level is established. When the referring customer reaches this second level of total referrals, a higher-value incentive is provided to the referring customer.

According to yet another alternative variation of the present method, an incentive is determined for a referring customer according to the total number of referrals in a particular time period (step 170). For example, in order to receive an incentive, a referring customer must make a minimum quantity of referrals over a particular period of time (e.g. a month). As such, a recurring motivation is established where a referring customer is required to make recommendations on a continuous basis in order to receive an incentive award. It can be appreciated that other methods for determining an incentive are possible and that the scope of the claims appended hereto is not intended to be limited to any of the example methods for determining an incentive herein presented. It should also be appreciated that the various alternative methods for determining an incentive, according to additional alternative variations of the present method, are used in conjunction with each other and any number of the illustrative methods described herein can be combined in various ways.

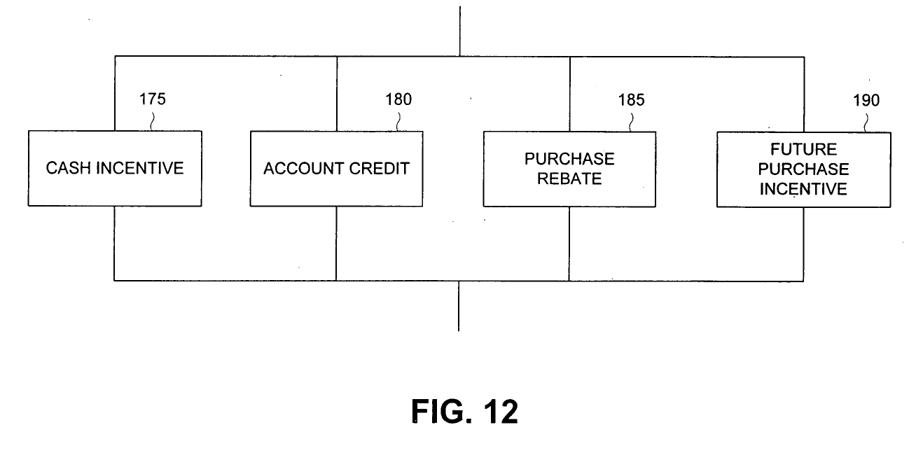

FIG. 12 is a flow diagram that depicts alternative methods for determining a form of an incentive for a referring customer. It should be appreciated that an incentive provided to a referring customer can take on various forms. For example, according to one variation of the present method, an incentive is provided to a referring customer in the form of a cash incentive (step 175). In yet another variation of the present method, an incentive is provided to a referring customer in the form of an account credit (step 180). An account credit includes, but is not necessarily limited to a credit to a customer rewards program account (e.g. a frequent-flier account or a frequent shopper account). An account credit, according to yet another variation of the present method, includes an account credit to a user's bank account. Although akin to a cash incentive, this variation of the present method is distinguished by crediting the users account as opposed to dispatching a check for a cash incentive.

According to yet another example variation of the present method, the form of a customer incentive includes a purchase rebate (step 185). According to this variation of the present method, a rebate on a particular previous purchase is provided to a referring customer. The rebate, according to yet another variation of the present method, takes the form of a cash incentive, which can be direct-deposited into a user's bank account. In yet another variation of the present method, an incentive for a referring customer is provided in the form of a future purchase incentive (step 190). For example, according to this variation of the present method, a future purchase incentive is provided to a referring customer in the form of a purchase coupon for a particular item. Likewise, according to yet another variation of the present method, a future purchase incentive takes the form of a discount coupon that comprises a general discount for purchases at a particular retail establishment or for products produced by a particular manufacturer. These are all merely examples of various forms of an incentive and are presented here only to further illustrate the present method and are not intended to limit the scope of the claims appended hereto.

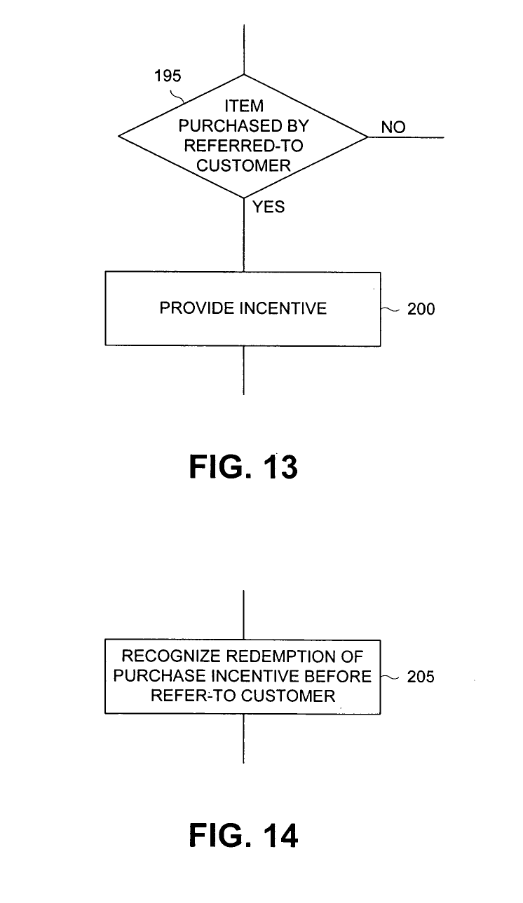

FIG. 13 is a flow diagram that depicts yet another variation of a method for determining when an incentive is provided to a referring customer based on the action of a refer-to customer. According to this variation of the present method, a referring customer is provided an incentive (step 200) when an item recommended by the referring customer is purchased by a refer-to customer (step 195).

FIG. 14 is a flow diagram that depicts an alternative example method for determining when a refer-to customer purchases a recommended item. According to this variation of the present method, a refer-to customer is provided with a purchase incentive for a particular recommended item. Accordingly, when the refer-to customer redeems the purchase incentive (step 205), this variation of the present method provides for recognizing the fact that a recommended item has been purchased by a refer-to customer. This, according to one alternative variation of the present method, is accomplished by recognizing a coupon that includes a user identifier for the referring customer and an item identifier that corresponds to the originally recommended and subsequently purchased item.

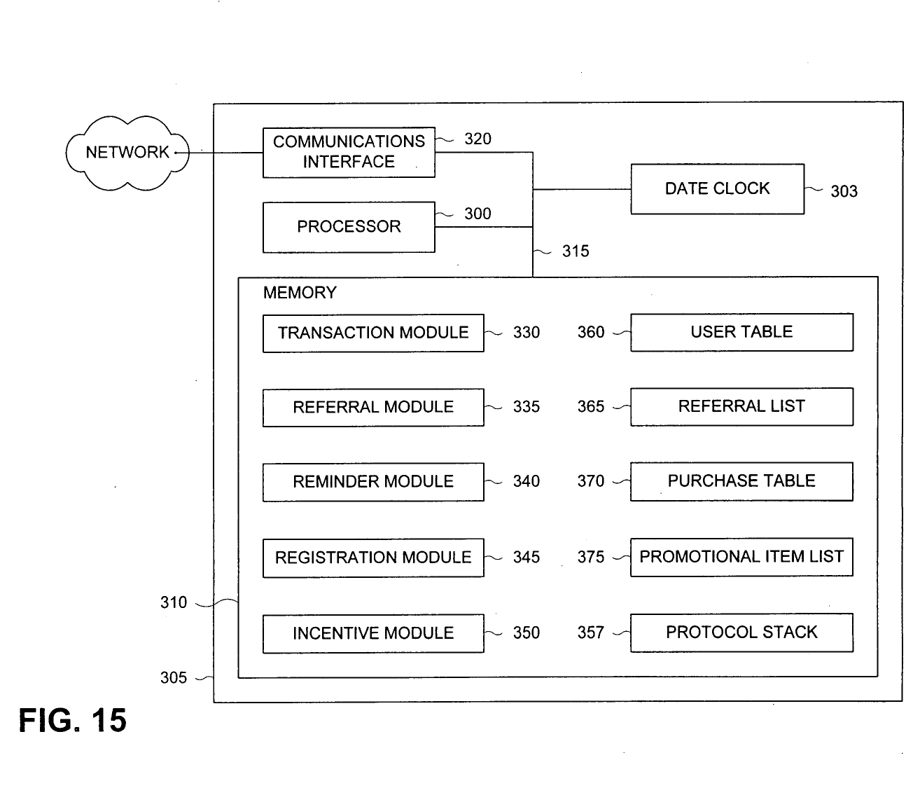

FIG. 15 is a block diagram that depicts several alternative example embodiments of an apparatus for rewarding a customer referral. According to one example embodiment, an apparatus for rewarding a customer referral 305 comprises a processor 300, a communications interface 320 and a memory 310. These elements are communicatively associated with each other by means of a bus 315.

Various example embodiments of an apparatus for rewarding a customer referral 305 as heretofore described further include various functional modules each of which comprises an instruction sequence that can be executed by the processor 300. An instruction sequence that implements a functional module, according to one alternative embodiment, is stored in the memory 310. The reader is advised that the term “minimally causes the processor” and variants thereof is intended to serve as an open-ended enumeration of functions performed by the processor 300 as it executes a particular functional module (i.e. instruction sequence). As such, an embodiment where a particular functional module causes a processor 300 to perform functions in addition to those defined in the appended claims is to be included in the scope of the claims appended hereto.

The functional modules (and their corresponding instruction sequences) described thus far that enable rewarding a customer referral are, according to one alternative embodiment, imparted onto computer readable medium. Examples of such medium include, but are not limited to, random access memory, read-only memory (ROM), Compact Disk (CD) ROM, Digital Versatile Disk (DVD), floppy disks, hard disk drives and magnetic tape. This computer readable medium, which alone or in combination can constitute a stand-alone product, can be used to convert a general-purpose computing device into a device for rewarding a customer referral wherein said device is capable of rewarding a customer referral according to the techniques and teachings presented herein. Accordingly, the claims appended hereto are to include such computer readable medium imparted with such instruction sequences that enable execution of the present method and all of the teachings herein described.

Stored in the memory 310 of one example embodiment are several functional modules including a transaction module 330 and a referral module 335. Yet another alternative example embodiment further includes a reminder module 340. The reminder module 340 is also stored in the memory 310. According to yet another illustrative embodiment, the apparatus further includes a registration module 345, which is stored in the memory 310. An incentive module 350 is stored in the memory 310 and further included in yet another alternative example embodiment. The memory 315 is also used to store various types of information organized as records in various tables including at least one of a user table 360, a referral list 365, a purchase table 370 and a promotional item list 375.

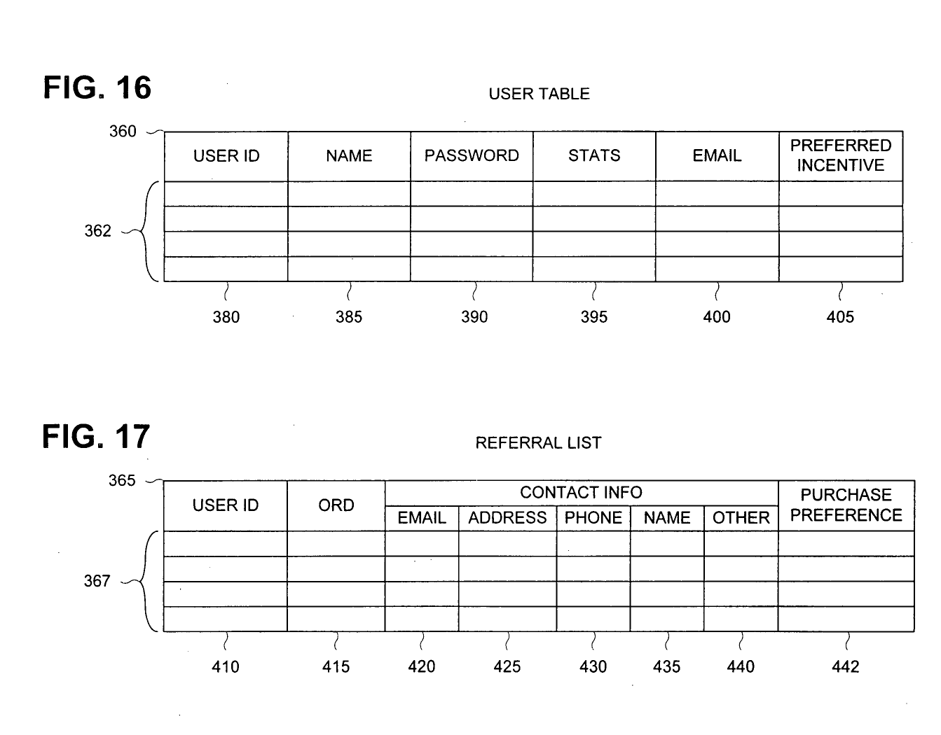

FIG. 16 is a pictorial diagram that illustrates one example embodiment of a user table. Various example embodiments include a user table, which is stored in the memory 310. According to one example embodiment, the user table 360 is used to store one or more records 362. According to one alternative embodiment, a record stored in the user table 360 includes a user identifier field 380. According to most embodiments herein described, the user identifier field 380 is used to store a user identifier, which is ordinarily used as a primary index for selecting records stored in the user table 360. In an alternative embodiment, the user table 360 includes a name field 385. The name field 385 is typically used to store the name of a user that has registered for incentives resulting from recommending an item according to the techniques and teachings presented herein. In yet another alternative example embodiment, the user table 360 includes a password field 390. It should be appreciated that, as a user interacts with the present apparatus, the user typically must authenticate such interaction. Accordingly, the password field 390 is used to store an initial password, which a user provides when registering with the apparatus. Upon subsequent interaction with the apparatus, a user must enter a password, which is then compared against a previously entered password that is stored in the password field 390.

In yet another alternative example embodiment, the user table 360 includes an e-mail field 400 for each record stored therein. The e-mail field 400 is used to store an e-mail address for a user which has registered with the apparatus. In yet another alternative embodiment, user activity is monitored and stored in a statistics field 395, included in a record stored in the user table 360. In yet another example embodiment, a user record stored in the user table 360 includes a preferred incentive field 405, the usage of which is described infra.

FIG. 17 is a pictorial diagram that illustrates one example embodiment of a referral list. According to one example embodiment, a referral list 365 is used to store one or more records 367. According to one alternative embodiment, the referral list 365 includes a user identifier field 410. It should be appreciated that the user identifier field 410 is typically relationally linked to a record in the user table 360. Accordingly, one or more records in the referral list 365 can be associated with any particular user identifier reflected in the user table 360. In such cases, one alternative embodiment of a referral list 365 includes an ordinal field 415. The ordinal field 415, according to one alternative embodiment, is used to distinguish amongst a plurality of records, wherein such records are all associated with the same user identifier (i.e. the value entered in the user identifier field 410 for all of these records is the same).

Each record in the referral list 365 corresponds to a contact entered by a user, wherein said contact is used as a target for a product and/or service recommendation. According to one alternative embodiment, a record stored in the referral list 365 includes a contact e-mail field 420, which is used to store an e-mail for a contact. According yet another alternative embodiment, a record stored in the referral list 365 includes a postal address field 425, which is used to store a postal address for a contact. In yet another example embodiment, the referral list 365 includes a phone field 430 for record stored therein. The phone field 430 is typically used to store a telephone number (e.g. a cellular telephone number, a home telephone number or a work telephone number). In yet another example embodiment, the referral list 365 provides a name field 435 for each record stored therein. The name field 435 is used to store a representation of a contact name. In yet another alternative embodiment, there is a miscellaneous (i.e. an “other”) field 440 provided for each record stored in the referral list 365. The other field 440 is used to store miscellaneous information pertaining to contact. One alternative embodiment of a referral table provides a purchase preference field 442, which is used to store purchase preferences that may be exhibited by a refer-to customer.

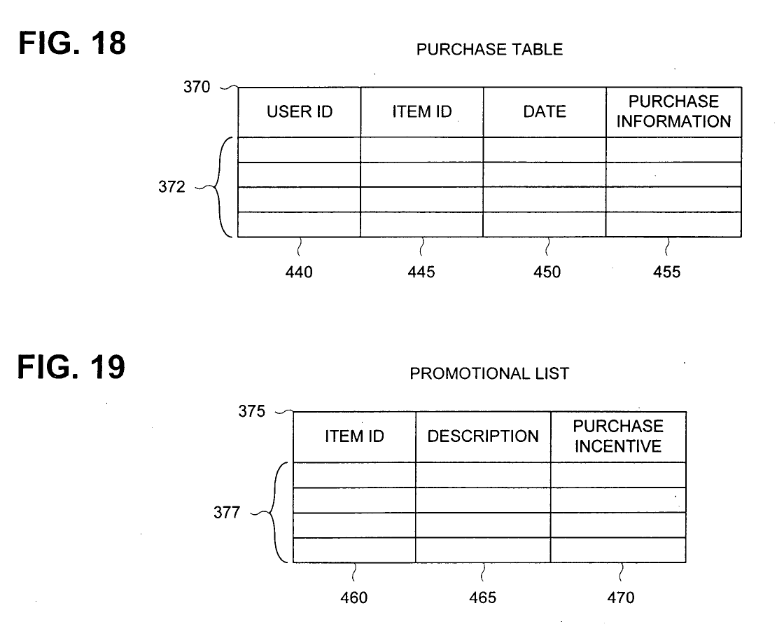

FIG. 18 is a pictorial diagram that illustrates one example embodiment of a purchase table. According to one example embodiment, a purchase table 370 is used to store one or more records 377, wherein each record corresponds to a purchase transaction. A purchase transaction, according to one example embodiment, is typically stored in the purchase table 370 according to a user identifier 442. Accordingly, one example embodiment of a purchase table 370 provides for a user identifier field 442, included in a record stored therein. A transaction is also typically stored according to an item identifier. Accordingly another example embodiment of a purchase table 370 provides for an item identifier field 445 in a record stored therein. The date upon which a purchase occurs is stored in a date field 450 included in a record stored in yet another alternative embodiment of a purchase table 370.

FIG. 19 is a pictorial diagram that illustrates one example embodiment of a promotional item list. It should be appreciated that one alternative embodiment of an apparatus for rewarding a customer referral does not note every purchase made by a registered user. Accordingly, a promotional item list 375 is used to identify certain items which are intended to be promoted by means of a referral (i.e. a recommendation). As such, one alternative embodiment of a promotional item list 375 stores one or more records 377, each of which includes an item identifier field 460. The item identifier field 460 is typically used as a primary index for records stored in the promotional item list 375. A record included in the promotional item list, according to yet another alternative embodiment, further includes a description field 465, which is used to store a description of an item identified by particular item identifier. In yet another alternative embodiment, details of a purchase incentive applicable to a particular item is stored in a purchase incentive field 470. Accordingly, this alternative embodiment of a promotional item list 375 further includes a purchase incentive field 470 in those records stored therein.

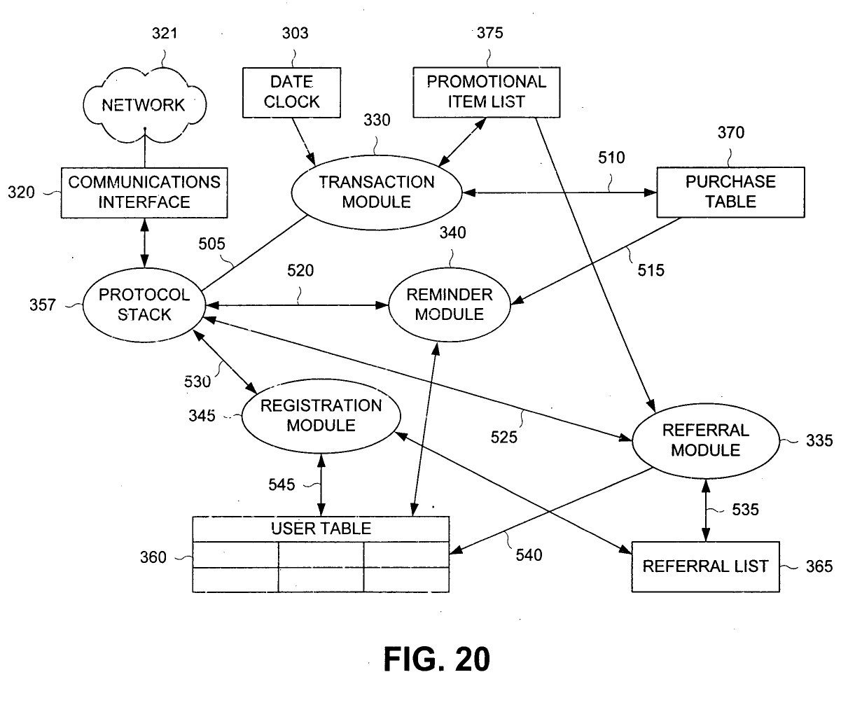

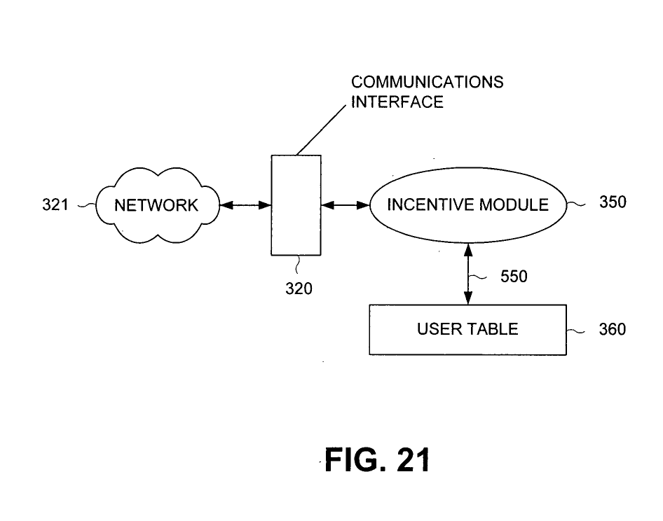

FIGS. 20 and 21 collectively constitute a data flow diagram that illustrates the internal operation of several example alternative embodiments of an apparatus for rewarding a customer referral. According to one alternative embodiment, the processor 300 executes a transaction module 330. The transaction module 330, when executed by the processor 300, minimally causes the processor to receive a transaction message 505 by means of the network interface 320. It should be appreciated that a transaction message, according to one alternative embodiment, includes at least one of a user identifier and an item identifier. The transaction module 330 further minimally causes the processor 300 to create 510 a new record in a purchase table 370. Typically, the user identifier and the item identifier are used collectively (442, 445) to distinguish a newly created record in the purchase table 370. According to yet another alternative embodiment, the transaction module 330 further minimally causes the processor 300 to retrieve a current date from a date clock 303, included in one alternative embodiment of an apparatus for rewarding a customer referral. According to yet another alternative embodiment, the transaction message further includes purchase information (e.g. price of the item, total number of items purchased and any discounts applied). Such additional information is stored in a purchase information field 455 in a newly created record 372 stored in the purchase table 370.

The processor 300 then executes the referral module 335. When executed by the processor 300, the referral module 335 minimally causes the processor 300 to receive a referral directive 525 by means of the communications interface 320. Accordingly, the referral module 335 selects contact information from the referral list 365 according to the referral directive. The referral module 335 further minimally causes the processor 300 to direct a referral to the network interface according to the selected contact information.

According to yet another alternative embodiment, the transaction module 330 causes the processor to create a record in the memory according to a transaction message by minimally causing the processor to extract an item identifier from the transaction message. The processor 300, as it continues to execute the transaction module 330, further minimally determines whether or not there is stored in the promotional item list 375 a record having a primary key (i.e. it's item identifier field 460) substantially equivalent to the item identifier extracted from the transaction message. According to this alternative embodiment, it is only when there is such a record stored in the promotional item list 375 that the processor 300 creates a transaction record in the purchase table 370 with continued execution of the transaction module 330.

According to one alternative embodiment, the referral module 335 causes the processor to receive a referral directive by minimally causing the processor 300 to execute a reminder module 340. As the processor 300 executes the reminder module 340, the processor is further minimally caused to retrieve a transaction record from the purchase table 370. The user identifier is that extracted from the transaction record as the processor 300 continues to execute the reminder module 340. Using the extracted user identifier, the reminder module 340 further minimally causes the processor 300 to select a user record from the user table 360 according to the extracted user identifier. The reminder module 340 then further minimally causes the processor 300 to retrieve a contact information from the selected user record. The reminder module 340 then further minimally causes the 300 to direct a request for recommendation to a user according to the retrieved contact information.

It should be appreciated that, according to one alternative embodiment, the reminder module 340 causes the processor 300 to request a recommendation by minimally causing the processor 300 to direct an e-mail message to a user by means of the communications interface 320. It should be further appreciated that the e-mail is directed according to an e-mail address retrieved from a selected record stored in the user table 360 as the processor 300 continues to execute this alternative embodiment of a reminder module 340. In yet another alternative embodiment, the reminder module 340 further minimally causes the processor 300 to include in such an e-mail one or more hot-links that correspond to a recommendation level. Accordingly, a user that receives such an e-mail can actuate one of the hot links in order to issue a referral directive. Accordingly, the processor 300 will recognize such a hot-link actuation as a referral directive as it executes one alternative embodiment of the referral module 335.

According to yet another alternative embodiment, the processor 300 executes the registration module 345. In operation, the processor 300 executes the registration module 345 when a user interacts 530 with the present apparatus in order to establish or maintain a user account. Accordingly, the registration module 345 minimally causes the processor 300 to establish 545 a new user record in the user table 360 when a new user engages in a new registration. A new user is identified by a user identifier, which is assigned by the processor 300 as it continues to execute this alternative embodiment of a registration module 345. One alternative embodiment of the registration module 345 further minimally causes the processor to receive a password, which is stored in a password field 390 of a newly created user record stored in the user table 360. According to yet another alternative embodiment, the registration module 345 further minimally causes the processor 300 to receive into a newly created record an e-mail address for a user. The e-mail address is stored in the e-mail field 400 included in the newly created record. It should be appreciated that any combination of one or all of such user attributes can be either entered upon an initial registration, or at any time subsequent to such an initial registration. Likewise, one alternative example embodiment of the registration module 345 further minimally causes the processor 300 to enable a user to modify any such user attributes stored in a corresponding user record.

When executed by the processor 300, the registration module 345 minimally causes the processor to receive by means of the network interface 320 contact information for one or more refer-to customers. A refer-to customer is a potential target of a product recommendation as heretofore described. The user identifier associated with a user is also used as a relational link between an entry in the user table 360 and one or more contact entries created in the referral list 365. According to one alternative embodiment, such interaction enables the processor to receive from the user at least one of an e-mail address, a postal address, a name a phone number and a purchase preference. Any combination of one or more of these is then stored 540 in the referral list 365. The processor 300, as it continues to execute the registration module 345, will create a new record in the referral list 365 for each refer-to customer identified by a user and will associate each such record with the user's particular user identifier, which is stored in the user identifier field of each such newly created record in the referral list 365.

According to one alternative embodiment, the referral module 335, when executed by the processor 300, minimally causes the processor to direct a referral to the network interface 320 by minimally causing the processor to direct an e-mail to a refer-to customer that is associated with a user identifier. It should also be appreciated that more than one record may be selected according to the user identifier, especially where a particular user has identified more than one potential refer-to customer in the referral list 365. In operation, the processor 300, as it continues to execute this alternative embodiment of a referral module 335, retrieves an e-mail from the referral list 365 according to a user identifier, wherein said user identifier is associated with a referral directive 525 received by the processor 300 as it executes the referral module 335. In order to ensure that a referral is directed to an interested party, one alternative embodiment of the referral module 335 further minimally causes the processor 300 to retrieve a description (description field 465) from the promotional item list 375 according to an item identifier. The retrieved description is correlated against a purchase preference for a particular potential refer-to customer identified in the referral list 365. Accordingly, this alternative embodiment of the referral module 335 further minimally causes the processor to retrieve a purchase preference from a purchase preference field 442 included in a selected record stored in the referral list 365. The purchase preference so retrieved is then correlated against the description of a particular item, as retrieved by the processor 300 from the promotional item list 375 as it continues to execute the referral module 335 of this alternative embodiment.

In one this alternative example embodiment, the e-mail directed to a refer-to customer further includes a purchase incentive. It should be appreciated that the purchase incentive is retrieved from the promotional item list 375 (from a purchase incentive field 470). It should be further appreciated that processor 300 selects a record in the promotional item list 335 according to an item identifier (item identifier field 460) corresponding to the item that is the subject of a referral.

One alternative embodiment of the referral module 335 further minimally causes the processor 300 to maintain user statistics according to referrals made by a particular user. Accordingly, such user statistics include at least one of a total quantity of referrals made for a particular item, a total quantity of referrals made and a quantity of referrals made during a particular interval of time. The referral module 335 causes the processor 300 to maintain such statistics in a statistics field 395 included in a record stored in the user table 360, wherein such record is selected by the processor 300 according to a user identifier (user identifier field 380) as it executes this alternative embodiment of the referral module 335.

One alternative embodiment of the incentive module 350, when executed by the processor, minimally causes the processor 300 to generate an incentive according to a record stored in the user table 360 and direct an incentive to a user according to contact information stored in the user table. For example, one alternative embodiment of the incentive module 350, when executed by the processor, minimally causes the processor 300 to retrieve an e-mail address (email address field 400 from the user table 360) and direct an incentive to the user by means of an e-mail message addresses according to the retrieved email address.

In one alternative example embodiment, the incentive module 350 causes the processor to retrieve 550 an activity statistic (statistics field 395) from a user record stored in the user table 360. According to various alternative embodiments, the incentive module 350, when executed by the processor, further minimally causes the processor 300 to grant a user incentive according to the retrieved activity statistic. According to one alternative example embodiment, the incentive module 350, when executed by the processor 300, minimally causes the processor 300 to retrieve from the user table 360 an indicator of a total quantity of referrals made by a user. In this alternative embodiment, the incentive module 350 further minimally causes the processor to compare the retrieved total quantity of referrals made to a threshold value. In the event that a user has met the threshold value for a total quantity of referrals made, this alternative embodiment of the incentive module 350 further minimally causes the processor to grant an incentive to the user.

In yet another alternative embodiment, the incentive module 350 further minimally causes the processor to retrieve from the user table 360 an indicator of a quantity of referrals made for a particular item. This alternative embodiment of the incentive module 350 further minimally causes the processor to retrieve a threshold for a particular promotional item from the promotional item list 375. The threshold is typically retrieved from a threshold field 473 (see FIG. 19). When a user meets the threshold level for a particular promotional item, this alternative example embodiment of the incentive module 350 further minimally causes the processor 300 to grant an incentive to the user.

In yet another alternative embodiment, the incentive module 350 further minimally causes the processor 300 to retrieve an indicator of a quantity of referrals made during a particular interval of time from the user table 360. This alternative embodiment of the incentive module 350, when executed by the processor 300, further minimally causes the processor to grant an incentive to user when the user has met a threshold for a quantity of referrals made during a particular interval of time (e.g. a month).

In one alternative example embodiment, the registration module 345, when executed by the processor 300, further minimally causes the processor 300 to allow a user to specify an incentive preference, which is typically stored in a preferred incentive field 405 included in one example of embodiment of a user table 360. According to various alternative embodiments, a user is allowed to specify a preference for incentive that includes a cash incentive, an account credit incentive, a purchase rebate and a future purchase incentive.

In a corresponding alternative embodiment of the incentive module 350, the incentive module 350, when executed by the processor, minimally causes the processor 300 to retrieve an incentive preference from the preferred incentive field 405 included in a selected record stored in the user table 360. It should be appreciated that the processor 300 selects a record according to a user identifier (user identifier field 380). In this alternative embodiment, the incentive module 350 minimally causes the processor to generate a user incentive according to the retrieved user preference.

In one alternative illustrative embodiment, the incentive module 350 minimally causes the processor to grant a user incentive in the form of a cash incentive. In this situation, the processor 300, as it continues to execute the incentive module 350, causes a negotiable item (e.g. a check) to be printed and dispatched to a user according to a postal address. In an alternative embodiment, the processor 300, as it continues to execute the incentive module 350, grants an incentive in the form of an account credit. In this alternative embodiment, the processor 300 creates an electronic funds transfer message, which the processor 300 directs to the communications interface 320. The electronic funds transfer message is directed to a bank clearing mechanism, thereby resulting in the deposit of a cash award incentive to a user's account.

In yet another alternative example embodiment, the incentive module 350, when executed by the processor 300, minimally causes the processor to generate an incentive in the form of a purchase rebate. In this alternative embodiment, the processor 300 directs a rebate message to the communications interface 320; directing the rebate message to at least one of a manufacturer and a retailer, which is then obligated to fulfill the rebate incentive.

In yet another alternative example embodiment, the processor 300 grants an incentive in the form of a future purchase incentive. Typically, the processor 300 generates a coupon, which can be redeemed by a user upon a future purchase of a product. According to one alternative embodiment, the incentive module 350 causes the processor to generate the coupon according to a purchase incentive reflected in a purchase incentive field 470 for a promotional item reflected in the promotional item list 375. In yet another alternative embodiment, such a coupon is e-mailed to the user, as heretofore described.

According to yet another alternative example embodiment, the incentive module 350, when executed by the processor, further minimally causes the processor 300 to receive a transaction message by means of the communications interface 320. Such transaction message typically comprises a redemption message, wherein a refer-to customer redeems a purchase incentive. Accordingly, this alternative example embodiment of the incentive module 350 further minimally causes the processor 300 to generate an incentive according to the received transaction message. The generated incentive is then directed to a user according to contact information stored in the user table 360 as heretofore described.

In yet another illustrative alternative embodiment, a transaction record that reflects redemption of a purchase incentive by a refer-to customer includes at least one of a user identifier and an item identifier for an item purchased according to the incentive. According to this alternative embodiment, the incentive module 350 causes the processor 300 to generate an incentive by minimally causing the processor 300 to extract a user identifier from the transaction record and select a record in the user table 360 according to the extracted user identifier. Accordingly, an incentive is determined by the processor according to at least one of an incentive preference (preferred incentive field 405) and an activity statistic (statistics field 395) included in the selected record.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

It should be appreciated that, although not explicitly described in the foregoing teachings, communications over the communications interface 320 included in one embodiment of an apparatus for awarding a custom referral is accomplished when a processor 300 executes a protocol stack 357. It should be further appreciated that the protocol stack 357 comprises an implementation of a communications protocol. According to one alternative embodiment, the protocol stack 357 implements the transmission control protocol/Internet protocol (TCP/IP). It should be further appreciated that, as the processor 300 executes the protocol stack 357, the processor 300 establishes a communications channel over the communications network 321 using the communications interface 320. It should likewise be appreciated that the protocol stack 357, when executed by the processor 300, minimally causes the processor 300 to engage in communications by means of a communications connection established with a remote process. Such a remote process, according to one alternative embodiment, comprises at least one of a referring customer terminal module, which executes in a referring customer terminal 20, a refer-to customer terminal module, which executes in a refer-to customer terminal 25, and a point-of-sale module, which executes in a point-of-sale terminal 15.

1. A method for rewarding a customer referral comprising:
recognizing a referring customer;
noting a purchase by the referring customer of an product;
receiving a product referral directive from the referring customer;
determining a refer-to customer; and
dispatching a product referral to the determined refer-to customer.

2. The method of claim 1 wherein recognizing a referring customer comprises accepting a user identifier.

3. The method of claim 1 wherein recognizing a referring customer comprises:
recognizing a user token;
perceiving information from the user token; and
determining a user identifier according to the perceived information.

4. The method of claim 1 wherein noting a purchase by the referring customer of an item comprises:
receiving an item identifier; and
noting a purchase when the item identifier corresponds to a promotional item.

5. The method of claim 1 wherein receiving a referral directive comprises:
reminding the referring customer of the purchase;
receiving a recommendation level for an item; and
determining a referral directive according to the recommendation level.

6. The method of claim 5 wherein reminding the referring customer of the purchase comprises dispatching an email to the referring customer.

7. The method of claim 5 wherein receiving a recommendation level for an item comprises:
providing a hot-link in an email that corresponds to a recommendation level; and
perceiving an actuation of the hot-link.

8. The method of claim 1 wherein determining a refer-to customer comprises:
receiving from the referring customer a contact information for a potential customer including at least one of an email address, a postal address, a name, a phone number and a purchase preference; and
identifying a refer-to customer according to the received contact information.

9. The method of claim 1 wherein dispatching a referral to a determined refer-to customer comprises emailing a purchase incentive for the item.

10. The method of claim 1 further comprising:
determining an incentive for the referring customer; and
providing the incentive to the customer.

11. The method of claim 10 wherein determining an incentive for the referring customer comprises determining an incentive according to at least one of a quantity of referrals made for a particular item, a total quantity of referrals made and a quantity of referrals made during a particular interval of time.

12. The method of claim 10 wherein determining an incentive for the referring customer comprises determining at least one of a cash incentive, an account credit, a purchase rebate and a future purchase incentive.

13. The method of claim 1 further comprising:
determining when an item is purchased by a refer-to customer; and
providing an incentive to the referring customer when an item is purchased by a refer-to customer.

14. The method of claim 13 wherein determining when an item is purchased by a refer-to customer comprises recognizing redemption by a refer-to customer of a purchase incentive.

15. An apparatus for rewarding a customer referral comprising:
processor capable of executing an instruction sequence;
network interface capable of enabling the processor to communicate over a data network;
memory capable of storing information and one or more instruction sequences; and
one or more instruction sequences stored in the memory including:
transaction module that, when executed by the processor, minimally causes the processor to:
receive a transaction message by means of the network interface, wherein the transaction message includes a user identifier and an item identifier; and
create according to the transaction message a transaction record in a purchase table stored in the memory; and
referral module that, when executed by the processor, minimally causes the processor to:
receive a referral directive for a transaction record by means of the network interface; and
select a contact information from a referral list stored in the memory according to the referral directive; and
direct a referral to the network interface according to the selected contact information.

16. The apparatus of claim 15 wherein the transaction module causes the processor to create a record in the memory according to a transaction message by minimally causing the processor to:
extract an item identifier from the transaction message;
determine if the extracted item identifier is included in a promotional item list stored in the memory; and
create a transaction record in a purchase table stored in the memory when the extracted item identifier is included in the promotional item list stored in the memory.

17. The apparatus of claim 15 further comprising a reminder module stored in the memory wherein the referral module causes the processor to receive a referral directive by minimally causing the processor to execute the reminder module that, when executed by the processor, minimally causes the processor to:
retrieve a transaction record from a purchase table stored in the memory;
determine a user according to the transaction table;
determine a contact for the user according to a user table stored in the memory; and
request a recommendation from the user according to the contact.

18. The apparatus of claim 17 wherein the reminder module causes the processor to request a recommendation by minimally causing the processor to direct an email to a user by means of the network interface according to an email address associated with a user identifier included in the transaction record.

19. The apparatus of claim 17 wherein the reminder module causes the processor to request a recommendation by minimally causing the processor to direct an email to a user by means of the network interface according to an email address associated with a user identifier included in the transaction record wherein said email includes a hot-link that corresponds to a recommendation level.

20. The apparatus of claim 15 further comprising a registration module that, when executed by the processor, minimally causes the processor to:
receive by means of the network interface a contact information for a refer-to customer that includes at least one of an email address, a postal address, a name, a phone number and a purchase preference; and
store the contact information in a referral list stored in the memory.

21. The apparatus of claim 15 wherein the referral module causes the processor to direct a referral to the network interface by minimally causing the processor to direct to the network interface an email that includes a purchase incentive, wherein the email is addressed according to a contact information associated with a refer-to customer that is associated with the user identifier.

22. The apparatus of claim 15 further comprising an incentive module that, when executed by the processor, minimally causes the processor to:
generate an incentive according to a record stored in the user table; and
direct the incentive to a user according to a contact information stored in the user table.

23. The apparatus of claim 22 wherein the incentive module causes the processor to generate an incentive by minimally causing the processor to:
retrieve an activity statistic from a user record stored in the memory; and
grant a user incentive according to the activity statistic wherein the activity statistic includes at least one of a quantity of referrals made for a particular item, a total quantity of referrals made and a quantity of referrals made during a particular interval of time.

24. The apparatus of claim 22 wherein the incentive module causes the processor to generate an incentive by minimally causing the processor to:
retrieve an incentive preference from a user record stored in the memory; and
grant a user incentive according to the incentive preference wherein the user preference includes at least one of a cash incentive, an account credit, a purchase rebate and a future purchase incentive.

25. The apparatus of claim 15 further comprising an incentive module that, when executed by the processor, minimally causes the processor to:
receive a transaction message by means of the network interface;
generate an incentive according to the transaction message; and
direct the incentive to a user according to a contact information stored in the user table.

26. The apparatus of claim 25 wherein the transaction record includes at least one of a user identifier for a referring customer and a item identifier for a purchased item and wherein the incentive module causes the processor to generate an incentive by minimally causing the processor to:
extract the user identifier from the transaction record;
select according to the user identifier a record in the user table stored in the memory; and
determine an incentive according to at least one of an incentive preference and an activity statistic retrieved from the selected record.
